(19) United States
(12) Patent Application Publication
(10) Pub. No.: US 2009/0154179 A1
(43) Pub. Date: Jun. 18, 2009

(54) Back bezel for use in a back light module

(75) Inventors: Nan-Ching Lee, Hsinchu (TW); Chung-Kuang Tsai, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU Optronics Corp., Hsinchu (TW)

(21) Appl. No.: 12/141,402

(22) Filed: Jun. 18, 2008

(30) Foreign Application Priority Data
Dec. 12, 2007 (TW) 96147361

(51) Int. Cl. F21V 21/02; F21V 21/00

(52) U.S. Cl. 362/432; 362/382

(57) ABSTRACT

A back bezel for use in a back light module is disclosed. The back bezel comprises a body and a reinforced structure. The body includes a plastic portion and a plurality of openings arranged in the plastic portion. The body further includes a first side and a second side opposite the first side. The reinforced structure of the back bezel is formed on the plastic portion to increase the structural strength of the body.

This application claims priority to Taiwan Patent Application No. 096147361 filed on Dec. 12, 2007, the disclosures of which are incorporated herein by reference in their entirety.

### CROSS-REFERENCES TO RELATED APPLICATIONS

Not applicable

### BACKGROUND OF THE INVENTION

1. Field of the Invention

The present invention relates to a back bezel for use in a backlight module, and particularly, relates to a lightweight plastic back bezel.

2. Descriptions of the Related Art

A conventional back bezel for use in a backlight module of a flat panel display adopts a galvanized steel plate or an aluminum plate as the primary material. As shown in FIG. 1, a reflective sheet 20 is attached on the reflecting surface of the back bezel 10, and then other elements such as a plurality of lamps 30, an optical film 40 and a main frame 50 are assembled on the reflective sheet 20 individually to complete the backlight module 1. However, such the back bezel 10 adopting a galvanized steel plate or aluminum plate as the primary material accounts for a substantial portion of the overall weight of the backlight module 1. For large-sized flat panel displays, this may result in an overweight assembly, so it is necessary to decrease the weight of the back bezel. Furthermore, a parasitic capacitance tends to occur between the metal back bezel and the cold cathode tube of the backlight module when the backlight module driven. This parasitic capacitance may decrease the driving efficiency of the cold cathode tube, and consequently have an adverse impact on the level and uniformity of the brightness on the panel.

In view of this, a plastic back bezel for use in a backlight module has been proposed in the prior art. This kind of lightweight plastic back bezel intends to replace the aforementioned metal back bezel and can decrease the weight of the backlight module, but also provides a lower structural strength than that of the metal ones. When used especially in a large-sized flat panel display, the inadequate structural strength of the plastic back bezel may incur a strain amount intolerable to other components of the backlight module and cause damage to the other components. Moreover, on the basis of current injection molding technologies applicable to plastic materials, it is difficult to form a large-sized plastic back bezel when the ratio of the flow length of the plastic material to the thickness thereof is excessively large. In other words, it is difficult to provide a back bezel with an inadequate thickness. Therefore, in practical applications, to form a plastic back bezel with the desired strength, the thickness of the large-sized back bezel must be increased to be more than twice the thickness of the metal back bezel. In this case, compared to the conventional metal back bezel, the thickened plastic back bezel does not lighten the weight of an actual flat panel display.

Accordingly, it is highly desirable in the art to provide a back bezel structure with both a light weight and adequate structural strength to overcome the problems associated with the overweight and parasitic capacitance of metal back bezels and inadequate strength of plastic back bezels in conventional large-sized flat displays.

### SUMMARY OF THE INVENTION

One objective of this invention is to provide a back bezel for use in a backlight module, which may effectively decrease the weight of a large-sized flat panel display while still providing the necessary structural strength.

The back bezel of this invention comprises a body and a reinforced structure. The body has a lightweight plastic portion and a plurality of openings arranged in the plastic portion. The body further has a first side and a second side opposite the first side. The reinforced structure is formed on the plastic portion to substantially increase the structural strength of the lightweight body.

In an embodiment of this invention, the supporting frame may be fastened or mounted at an appropriate location on the first side of the body to appropriately reinforce the structural strength of the back bezel. Furthermore, the supporting frame may be formed with a wall-hanging hole to detachably secure a flat panel display comprising the backlight module on a wall, thereby integrating the conventional wall-hanging bracket into the supporting frame of this invention. Additionally, the supporting frame may be formed with securing holes to integrate the connection and attachment structures for conventional system elements into the frame structure of this invention, so that at least one system element (e.g., a power supply, a system circuit board, and a video circuit board) is detachably fastened to at least one supporting frame. This may decrease both the cost and weight of the flat panel display as a whole by reducing the number of parts in the display.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an exploded schematic view of a conventional backlight module;

FIG. 2A and FIG. 2B illustrate the front and back view of a back bezel in accordance with the embodiment of this invention respectively;

FIG. 3 illustrates the back view of a back bezel in another embodiment of this invention;

FIG. 4A and FIG. 4B are schematic cross-sectional views of a supporting frame for use in a back bezel of this invention; and

FIG. 5 is an exploded schematic view illustrating an application of the back bezel in a backlight module in accordance with an embodiment of this invention.

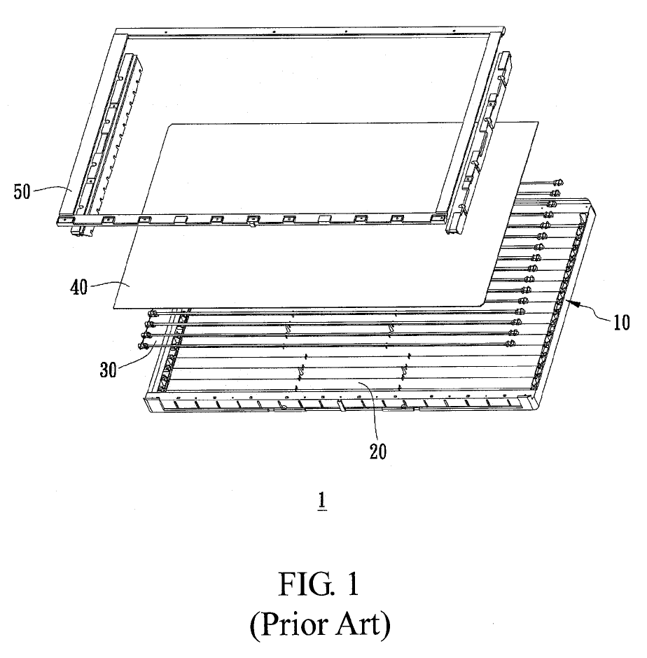

### DESCRIPTION OF THE PREFERRED EMBODIMENT

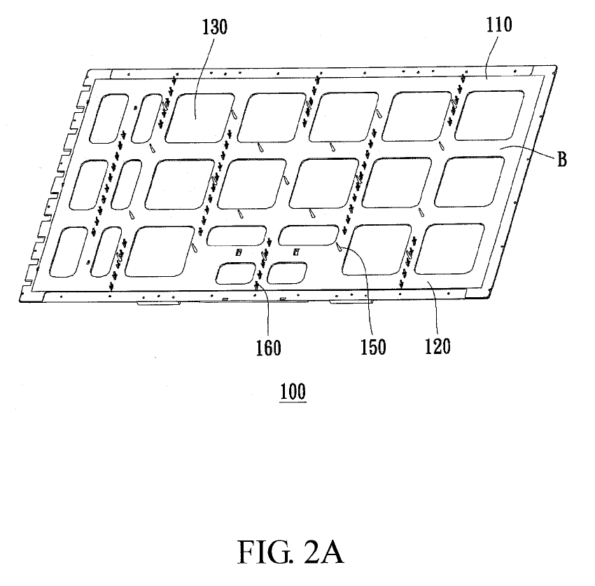

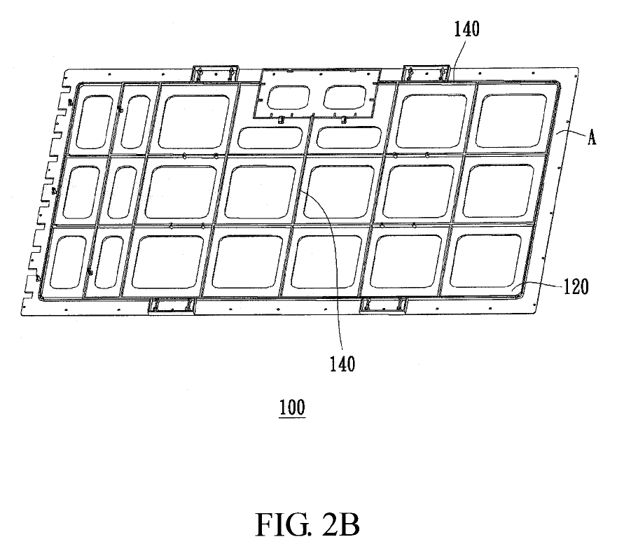

FIGS. 2A and 2B illustrate the front and back view of a back bezel in an embodiment of this invention. The back bezel 100 of this invention primarily comprises a body 110 and a reinforced structure 140. The body 110 has a first side A and a second side B opposite the first side A. In this embodiment, the second side B of the body 110 is defined as the front side of the back bezel 100, i.e., the reflecting side of the backlight module. The first side A of the body 110 is defined as the back side of the back bezel 100.

As previously described, to cater for the demands for a lightweight large-sized flat panel display, the conventional metal back bezel is also replaced with a plastic back bezel 100 in this invention. Hence, the body 110 of the back bezel 100 further has a plastic portion 120, and a plurality of openings 130 arranged in the plastic portion 120 to decrease the overall weight of the plastic back bezel 100. The rectangular profile of the openings 130 depicted in the drawings is only for purpose of illustration but not to limit the scope of this invention. For example, the openings may also have a circular profile. In the preferred embodiment, the body 110 of the back bezel 100 is preferably made of a heat-resistant plastic material such as polycarbonate (PC).

The reinforced structure 140 is formed on the plastic portion 120 of the back bezel 100, for example but not limited to, on the first side A, to substantially increase the structural strength of the body 110. As shown in FIG. 2B, the reinforced structure 140 may be arranged on the periphery and/or a central area of the plastic portion 120 depending on the actual locations to be reinforced in the body 110, thereby reinforcing the structural strength of the plastic back bezel. Furthermore, the reinforced structure 140 may comprise a plurality of solid or hollow ribs in itself. The hollow ribs are, for example but not limited to, formed integrally with the plastic portion 120 through a gas-assisted injection molding process. In the preferred embodiment of this invention, hollow ribs increasingly widened in the cross-section from top to bottom are formed on the periphery of the plastic portion 120 through the gas-assisted injection molding process to effectively increase the structural strength of the body 110. As shown in FIG. 2A, the back bezel 100 further comprises at least one spacer pin 150 and at least one lamp supporting frame 160 disposed on the second side B of the body 110. In the preferred embodiment, a plurality of spacer pins 150 and a plurality of lamp supporting frames 160 are disposed at appropriate locations on the second side B to support certain members (e.g., optical films) and lamps respectively.

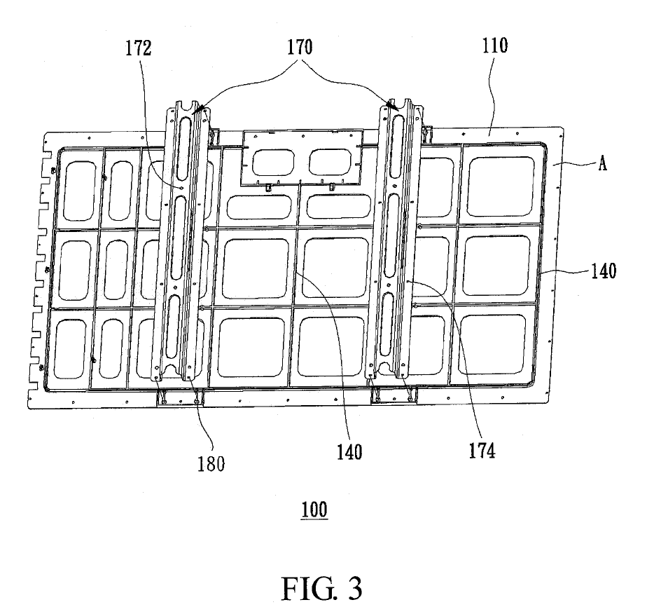

FIG. 3 illustrates the back view of a back bezel in another embodiment of this invention. In this embodiment, the back bezel 100 of this invention further comprises at least one supporting frame 170 detachably fixed onto the first side A of the body 110. In particular, the supporting frame 170 may be fastened to the body 110 by means of at least one fastening assembly, for example, by means of screws (not shown) in conjunction with screw holes 180, although it is not just limited thereto. Additionally, although the two supporting frames 170 are shown in this figure, only a single or more than two supporting frames may also be used depending on the strength requirements of the back bezel structure in application.

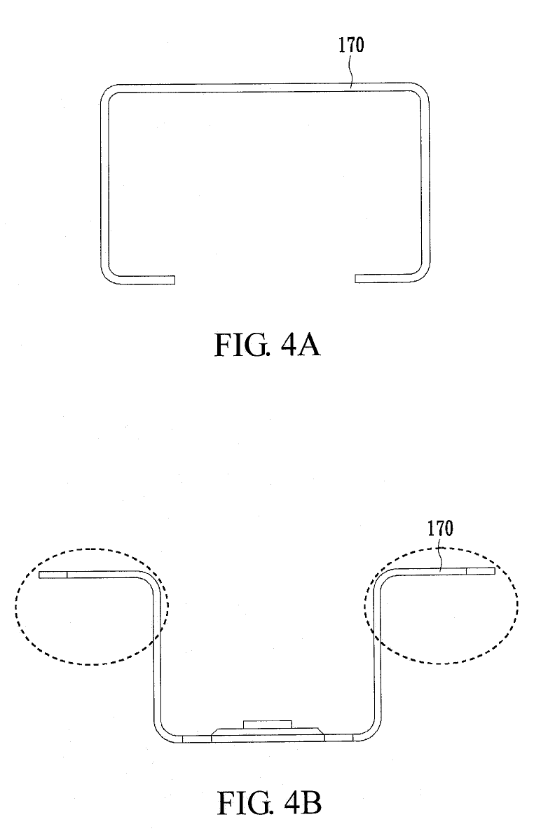

The supporting frames 170 are preferably made of a metal material, and may also be made of a resin material to further increase the structural strength of the whole back bezel 100 and particularly of large-sized back bezels. In reference to both FIGS. 4A and 4B, schematic cross-sectional views of a supporting frame in an embodiment are illustrated therein, in which FIG. 4A illustrates a C-shaped supporting frame structure, and FIG. 4B illustrates a U-shaped supporting frame. Specifically, the supporting frame 170 illustrated is a hollow cylinder, which has a receiving space formed therein to integrate at least one circuit used for other electronic components of the backlight module. More particularly, when the receiving space inside the supporting frame 170 has been filled with connection circuits used in the backlight module, both ends (shown by dashed circles) of the U-shaped supporting frame structure shown in FIG. 4B may further provide an arrangement for connection circuits of the backlight module. As may be appreciated by those skilled in the art, the cross-section structure of the supporting frame shown herein is only for purpose of illustration, but not to limit the scope of this invention.

Furthermore, in reference to FIG. 3, the supporting frame 170 in the back bezel 100 of this invention is not only used to reinforce the overall structure, but may also be used in the integration to reduce the number of parts in the backlight module. In more detail, to effectively lighten the weight in a large-sized flat panel display, the supporting frame 170 may be integrated with wall-hanging brackets (not shown) conventionally used to hang the whole flat panel display. For example, at least one wall-hanging hole 172 may be disposed on the supporting frame 170 to detachably fasten a flat panel display comprising the supporting frame on a wall, so that the wall-hanging brackets conventionally needed to hang the flat panel display is integrated into the supporting frame structure of the back bezel of this invention. On the other hand, the supporting frame 170 may also be formed with at least one securing hole 174 to detachably secure the system elements (not shown, e.g., at least one system circuit board, video circuit board, power supply and the like) comprised in the backlight module onto the supporting frame 170. In this way, the frames conventionally needed in the flat panel display to fasten the system elements are integrated into the supporting frame structure of the back bezel of this invention, thus obtaining a more lightweight flat panel display.

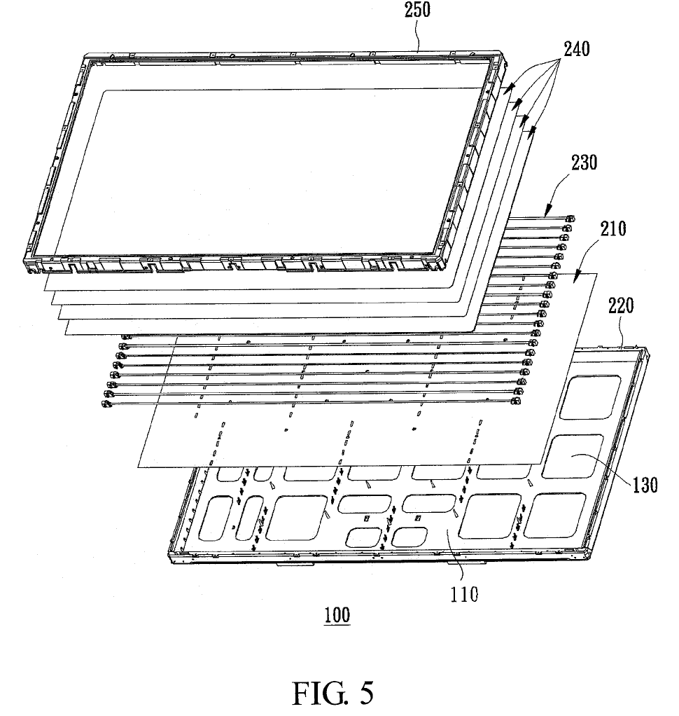

FIG. 5 illustrates an exploded schematic view of an application of a back bezel 100 in a backlight module 200 in an embodiment of this invention. The back bezel 100 in this embodiment is attached with an opaque reflective sheet 210 to effectively prevent unexpected light leakage at the openings 130 of the back bezel 100. Next, the back bezel 100 is mounted on the side frame 220, and then a plurality of lamps 230 are mounted on the reflective sheet 210. Subsequently, a plurality of optical films 240 and a main frame 250 are mounted in a manner used to assemble a backlight module conventionally.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A back bezel for use in a back light module, comprising:
a body, having a plastic portion and a plurality of openings arranged in the plastic portion; and
a reinforced structure, formed on the plastic portion, adapted to substantially increase structural strength of the body.

2. The back bezel as claimed in claim 1, wherein the plastic portion has a peripheral area on which the reinforced structure is formed.

3. The back bezel as claimed in claim 1, wherein the plastic portion has a central area on which the reinforced structure is formed.

4. The back bezel as claimed in claim 1, wherein the reinforced structure comprises a plurality of solid ribs.

5. The back bezel as claimed in claim 1, wherein the reinforced structure comprises a plurality of hollow ribs.

6. The back bezel as claimed in claim 5, wherein the hollow ribs are integrated with the plastic portion by a gas-assisted injection molding method.

7. The back bezel as claimed in claim 1, wherein the body further has a first side and a second side opposite to the first side.

8. The back bezel as claimed in claim 7, further comprising a supporting frame, detachably fastened on the first side of the body.

9. The back bezel as claimed in claim 8, further comprising at least one fastening assembly, adapted to detachably fasten the at least one supporting frame on the first side of the body.

10. The back bezel as claimed in claim 9, wherein the fastening assembly has a screw and a screw hole.

11. The back bezel as claimed in claim 8, wherein the at least one supporting frame is made of metal materials.

12. The back bezel as claimed in claim 8, wherein the at least one supporting frame is made of resin materials.

13. The back bezel as claimed in claim 8, wherein the at least one spacer is a hollow cylinder, adapted to receive at least one circuit.

14. The back bezel as claimed in claim 8, wherein the at least one supporting frame has at least one securing hole, adapted to detachably secure at least one circuit board on the at least one supporting frame.

15. The back bezel as claimed in claim 8, wherein the at least one supporting frame has at least one wall-hanging hole, adapted to detachably secure a display, comprising the back light module, on a wall.
